(19) United States
(12) Patent Application Publication
(10) Pub. No.: US 2004/0233043 A1
(43) Pub. Date: Nov. 25, 2004

(54) Communication system

(75) Inventors: Yoshiaki Yazawa, Nishitokyo (JP); Masao Kamahori, Kokubunji (JP); Ken Takei, Kawasaki (JP); Takehiro Ohkawa, Tachikawa (JP); Hiroshi Yoshigi, Hinode (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/705,894

(22) Filed: Nov. 13, 2003

(30) Foreign Application Priority Data
May 23, 2003 (JP) 2003-145610

(51) Int. Cl. H04Q 5/22

(52) U.S. Cl. 340/10.3; 340/10.34; 340/10.41; 435/6

(57) ABSTRACT

A communication system is provided which enhances communication stability, using chips on which function blocks are formed including sensor, chip ID, and radio transmission/reception functions. The sensor detects biological and chemical materials and physical and stoichiometric quantities such as temperature, pressure, and pH and the sensed results are transmitted to a reader by a radio frequency (RF) function. The chip with the sensor functions at a resonance frequency which is detected by the reader initially during a frequency sweep. No dedicated power source is essential to operate the chips, but instead the chips are triggered into transmitting by the radio frequency signals transmitted from the reader. The frequency and output of transmission from the reader to the chips are variable. Stable communication can be performed without being affected by variation in the chips characteristics depending on manufacturing quality.

### PRIORITY CLAIM

This application claims priority to Japanese patent application P2003145610 filed May 23, 2003, the entire disclosure of which is hereby incorporated herein by reference.

### BACKGROUND OF THE INVENTION

1. Field of the Invention

The present invention relates to a communication system which transmits the results of detection of biological materials such as nucleic acids, proteins, antigens, and antibodies and the measurements of physical and stoichiometric quantities such as temperature, pressure, light, and ion concentration to external equipment in a non-contact manner.

2. Description of Related Art

With the findings of genome sequences and the development of gene analysis technology, in recent years, accumulation of knowledge on associating diseases and drug sensitivity with genes has augmented rapidly. Using such information, by investigating gene expression under various conditions and gene mutation in a variety of organisms, the functions of genes and the association of genes with diseases and sensitivity to drugs and medicines are identified and it is being revealed how gene expression networks and single nucleotide polymorphisms (SNPs) in genes have relation to a particular illness and constitution.

When diagnosing diseases, using gene information, gene inspection is believed to be typing of known genes and their mutations. While techniques for processing large quantities of samples at a high speed are required in seeking unknown genes and mutations, an inspection process which can easily be performed for relatively small quantities of samples at low cost is desirable for typing and several methods for achieving such a process have been devised. As a system that can be used for SNPs analysis and gene inspection, for example, a microarray system has been reported (for example, Non-Patent Document Cited 1, Nature Gent. 18, 91 (1998).

In a microarray, spotting diverse oligo-DNAs or cDNAs on glass slides coated with poly-L-lysine is performed. Spotting is performed by a spotter which can form spots with dozens of micrometers to 200 μm in diameter at a pitch of 100-500 μm. After spotting, the samples on the glass slides are post processed and dried and kept intact at room temperature. For target sample preparation, RNA is extracted from a sample cell and, from the RNA, cDNA labeled by fluorescent dye such as Cyanine3 and Cyanine5 is prepared. The target sample solution is dropped on the above microarray and the microarray is incubated for about 10 hours at 65° C. in a moisture chamber. After the completion of hybridization, the microarray is washed with a 0.1% SD solution and dried at room temperature. For assaying the microarray, a scanner is used. As a light source for excitation, for example, an argon ion laser is used. As an emission detector, for example, a photomultiplier tube is used. Using confocal optics, the influence of background light in the periphery of the focal point is eliminated and the S/N ratio is enhanced. To assay fluorescent emission from many spots, it is necessary to position the microarray to the reading optics with high precision. Thus, a translational stage which allows for translational movement within an error of dozens of micrometers is built into the scanner.

Also, an antenna and card-form storage medium assembly for writing and reading of data in a non-contact manner has been reported (for example, Patent Document Cited 1, JP-A No. 165132/2000). This assembly includes means for converting load resistance which converts the load resistance of electronic circuitry from the perspective of the antenna to a predetermined value. By the load resistance converting means, the maximum electromotive force is supplied to the electronic circuitry connected, thereby making the electronic circuitry always operate logically and efficiently.

[Patent Document Cited 1]

JP-A No. 165132/2000

[Non-Patent Document Cited 1]

Nature Gent. 18, 91 (1998)

As for the DNA microarray which attracts attention as a gene inspection method, because the quantities and shapes of the spotted solutions lead to variation in the measurements of fluorescence intensity in the assay process, performance of forming highly uniform spots is important. In practical operation, however, such variation in the measurements due to non-uniform spots was not avoidable.

As for the antenna and card-form storage medium assembly for writing and reading of data in a non-contact manner disclosed in Patent Document Cited 1, the card-form storage medium assembly includes the means for converting the load resistance of electronic circuitry from the perspective of the antenna to a predetermined value, but it was not able to overcome card-by-card resonance frequency variation due to variation in manufacturing the card-form storage media.

### SUMMARY OF THE INVENTION

The present invention uses miniature chips, each of which comprises a sensor which detects the quantity of a target of a type which differs per chip or related physical and stoichiometric quantities such as temperature and pressure, circuit blocks having different functions of signal processing to manipulate sensed data, non-contact communication control, retaining chip ID number and ID comparison, and power supply generation and control, a coil for communicating with an external control device, and capacitance. The chips are installed to be in contact with different sample solutions and each chip detects the quantity of a target of a type which differs per type or related physical and stoichiometric quantities such as temperature and pressure and converts a signal detected into a digital electric signal. On the other hand, an external reader transmits a chip ID code to identify a particular chip out of a plurality of chips, using means of transmission which may be electromagnetic waves, change in a magnetic field, or change in an electric field.

Between the foregoing reader/writer and a micro-transponder consisting of a transponder provided with a sensor, information about chemical reaction obtained by a probe appropriate for the object to be detected is transmitted from the transponder to the external reader/writer and several methods are possible to carry out such transmission by wireless means. Although several media are possible to be used for the transmission methods, focusing on that the reader/writer performs information processing electrically, according to a journal that provides relevant information, when consistency with circuitry is considered, the use of electromagnetic waves as a transmission medium is advantageous in cost reduction, in comparison with, for example, a method in which ultrasonic waves are used as a transmission medium, because the use of electromagnetic waves can dispense with new converters for conversion of ultrasonic waves to electrical signals and vice versa.

There are three basic modes of transmission of electromagnetic waves in free space: near field, inductive field, and radiation field. Even if information is transmitted on electromagnetic waves, the system configuration and the structures of constituent devices greatly change, depending on which of the above three modes is used. For the system using the radiation field, radio interfaces between the transponder and the reader/writer are antennas and usable frequencies are limited to make the antenna efficiency sufficiently great. If the dimensions of the transponder are a few square millimeters (1×1 mm² to 3×3 mm²), radiation efficiency is assumed to be about −20 dB if 1 GHz is used and about −10 dB if 10 GHz is used. To prevent the influence of external noise, it is necessary to select a frequency band of the order of 10 GHz. Even with the state of art semiconductor technology, semiconductor integration technology is not sufficient to fabricate such a small chip. Thus, transponders as small as a few square millimeters are impossible to realize or high cost devices even if they can be produced and the problem of prior art cannot be resolved. Use of the near field, in electrical circuitry, a capacitor is formed between the transponder and the external control device and information is transmitted in the radio space, taking advantage of change in electric charges in the capacity. Accordingly, the electric charges which carry information must be localized in correct position. In principle, it is impossible to hold down increase in the manufacturing cost regarding the accuracy of charge localization and, consequently, the problem of prior art cannot be resolved. In the spatial transmission of information using the inductive field, information is transmitted, taking advantage of energy movement produced by a transformer which is formed between the coil of the transponder and the coil of the reader/writer. A magnetic field generated by the primary coil of the transponder is captured by the coil of the reader/writer and the resulting magnetic path functions as the transmission path through which communication is performed. Because of the property of magnetic field energy that is ubiquitous broadly in space, in principle, positional relationship between the transponder and the reader/writer does not require high accuracy. Once the magnetic path has been formed in the inductive field, information is transmitted along the magnetic path, or in other words, through the unspread channel. Thus, the use of the inductive field can significantly enhance the efficiency of transmitting energy to the external space, as compared with the mode of using the radiation field in which electromagnetic waves are radiated broadly in space by the antennas. Therefore, when using electromagnetic waves as the medium of transmitting information between the transponder and the reader/writer, selecting the inductive field is advantageous in order to solve the problem of prior art.

In order to obtain a good efficiency of transmitting information by radio, using the inductive field, the following points should be noted. First, due to variation in manufacturing transponders and depending on the circumstances where the transponders are placed, the resonance frequency of the transponders may shift and stable communication must be performed without being affected by such a shift. The resonance frequency greatly varies, depending on the components of a resonance circuit such as the coil, capacitance, and resistors of the transponder and, in addition, the presence of other conductors located outside the transponder. Although it is possible to adjust the resonance frequency by trimming, it is undesirable to add such a process to the transponder manufacturing process because doing these increases the cost and such adjustment is ineffective for change due to the circumstances around the transponder when measurements are taken. The magnetic path during actual measurement may change, depending on the positional relationship between the transponder's coil and the coil of the reader/writer. Communication may become impossible when the transponder and the reader/writer are placed in circumstances of worse conditions than the positional relationship expected in the design phase, whereas breakdown of the transponder may occur by excessive power generated when the transponder is in closer proximity to the reader/writer than expected in the design phase. Thus, without exerting high precision control of relative positional relationship between both coils, it is essential to provide means for enabling stable communication which produces an equivalent effect to such control.

In order to carry out stable communication without being affected by shifts in the resonance frequency of the above-mentioned chips as transponders, the frequency at which the magnetic field that is generated in the reader changes is set variable, according to the resonance frequency of the chip to communicate with. To find the resonance frequency of an individual chip, a frequency sweep is first performed for the chips. In the frequency sweep, first, the reader sends changing frequency bands to the chips. Then, the chips reply at their optimum resonance frequencies and return their chip IDs to the reader at their optimum resonance frequencies. The reader relates the optimum frequency to the chip ID (ID number) for each chip and stores the correspondence between the optimum frequency to the chip ID (ID number). This correspondence may be stored on the reader itself or on external means (data storage etc.) for storing information. After the frequency sweep, the reader communicates with the chips at the optimum frequencies per chip.

The above is required for the following reason. During the process of manufacturing the internal coils of the chips and the input/output impedances of rectification, detection, and other circuits connected to the internal coil on each chip, the individual chips may come to have different optimum resonance frequencies in a dispersion range. By incorporating the above-described means into the invented system, communication between the reader and the chips can be performed at optimum frequency bands per chip, accommodating variation in the resonance frequency per chip. Concretely, to enhance the stability of communication, the frequency at which the external control circuit uses for transmission is varied over time and, accordingly, a magnetic path is formed by magnetic flux generated by the magnetic path and signals are transmitted and received through the magnetic path. Manufacturing variation of the internal coil and manufacturing variation of input and output impedances of circuits such as rectification and detection connecting to the internal coil reflect on variation in the frequency characteristics in the impedance matching state of the internal coil and the circuits such as rectification and detection. Because the shape and size of the external coil of the reader (or external control device) can usually be ten times as much as the shape and size of the internal coil, change in the matching state of the external coil and the circuits of the reader such as rectification and detection due to external coil size variation is negligibly small as compared with the case of the internal coil. Therefore, the frequency that is used for forming a magnetic path between the reader and chip, in other words, used for communication is varied over a suitable frequency band and a magnetic path is formed by magnetic flux generated by the external coil and signals are transmitted and received through the magnetic path. For a plurality of chips, communication at a suitable frequency is effected by which a good matching state specific to each chip internal coil and circuits such as rectification and detection takes place. In this way, a magnetic path can be formed efficiently between the internal coil and external coil, thus avoiding lowering communication stability by chip manufacturing variation. In other words, a problem of signal deterioration caused by energy generated when a magnetic path is formed by magnetic flux generated by the external coil, which is caused by chip manufacturing variation, need not be considered in the system. Thus, the allowance range of chip manufacturing variation can be extended and, consequently, chip manufacturing cost can be curtailed greatly.

In the present invention, to enhance the probability that a magnetic path is formed between the internal coil mounted on the chip and the external coil of the reader (or external control device), the reader (or external control device) repeats, by a plurality of times, a process which comprises generating magnetic flux by the external coil, forming a magnetic path, transmitting and receiving signals through the magnetic path. This is easily implemented by repeating signal processing using the external coil of the reader (or external control device) by a plurality of times.

In the present invention, with fluctuation in electric power excited on the chip, according to positional relationship between the chip's coil and the reader's coil, chip breakdown if the distance between both coils becomes too short is prevented. For this purpose, the reader controls RF output while monitoring the output of signals from the chips. Even for a chip whose distance from the reader greatly diverges from its normal position, stable signal reading can be performed.

Communication stability also varies, depending on the magnetic path during actual measurement, that is, the positional relationship between the chip's coil and the reader's coil. To enhance communication stability and prevent chip breakdown by excessive electric-power generated when the chip and reader come in mutual close proximity, it is advisable to adjust current amperage flowing across the reader's coil while monitoring the signals from the chips.

According to the present invention, a simple communication system without requiring peripheral devices can be provided at a low cost. As a solution to resonance frequency variation per chip due to variation in manufacturing the chips and depending on the circumstances where the chips are placed, for example, buffer solutions including different samples, other chips, or reaction containers exist around a chip, by adjusting the carrier frequency to the resonance frequency of the chip to communicate with, communication can be stabilized. Each chip transmits the result of comparing the chip ID number retained on the chip with sensed data from raw data detected by the sensor of the chip to the reader, and communication of data compared with the chip ID number can be performed stably. When measurements are taken with a plurality of chips having different sensor functions, a diverse range of measurements of materials can be taken and checked substantially at a time and quickly.

The invented communication system enables in-situ inspection for a variety of objects at hospitals without a specialized inspection department, general hospitals which are not contracted inspection agencies, food factories, food-providing agencies, and distribution agencies.

### BRIEF DESCRIPTION OF THE DRAWINGS

FIG. 1 is a schematic diagram showing a communication system configuration example according to Embodiment 1 of the present invention;

FIG. 2 is a schematic diagram showing a communication system configuration example according to Embodiment 2 of the present invention;

FIG. 3 is a schematic diagram showing a communication system configuration example according to Embodiment 3 of the present invention;

FIG. 4 is a diagram showing an example of a time sequential procedure of transmitting data between the reader and the chip according to Embodiment 4 of the present invention;

FIG. 5 is a diagram showing an example of a time sequential procedure of transmitting data between the reader and the chip according to Embodiment 5 of the present invention;

FIG. 6 is a schematic diagram showing a reader configuration example featuring signal peak detection and output control, according to Embodiment 6 of the present invention;

FIG. 7 is a schematic showing a measurement system application example to a plant, according to Embodiment 7 of the present invention, as a communication system configuration example for wirelessly measuring liquid conditions in a pipe, using chips installed inside the pipe and a reader installed outside the pipe;

FIG. 8 is a schematic showing a communication system configuration example in which the passage of magnetic lines of force is provided in a chip installation position, according to Embodiment 7 of the present invention;

FIG. 9 is a schematic showing a communication system configuration example which performs monitoring of a plurality of pipings over a long distance and in which chips are installed in pipes and readers and coils are installed outside and near the pipes, the readers featuring a wireless communication function, according to Embodiment 8 of the present invention; and

FIG. 10 is a schematic showing a communication system configuration example which performs monitoring of a plurality of synthetic reaction baths over a long distance and in which chips are installed inside synthetic reaction baths and readers and coils are installed outside and near the baths, the readers featuring a wireless communication function, according to Embodiment 8 of the present invention.

### DETAILED DESCRIPTION OF THE PREFERRED EMBODIMENTS

[Embodiment 1]

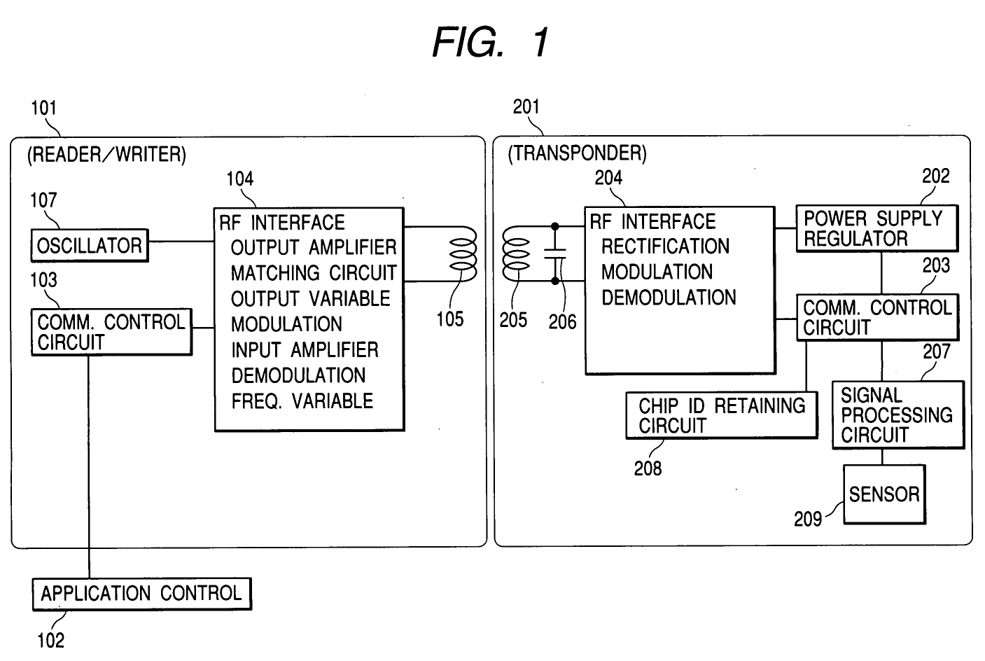

A preferred Embodiment 1 of the present invention will now be described with reference to FIG. 1. FIG. 1 is a schematic diagram showing the structures of the electric circuitry blocks of a reader and a chip in a measurement system of the present invention. The reader 101 is comprised of a radio frequency (RF) interface block (RF control unit, and the same will apply hereinafter) 104, an oscillator block 107, a communication control circuit block 103, and an external coil 105. The reader is controlled b an application control block 102. The RF interface block is a circuit block having RF signal transmission and reception functions. Carriers generated by the oscillator 107, after being modulated by a signal generated by the communication control circuit, are amplified by an output amplifier, according to an output variable function, and fed to the external coil of the reader.

The chip is comprised of an internal coil 205, a capacitor 206 which is a component of a resonance circuit, an RF interface 204, a power supply regulator 202, a communication control circuit 203, a chip ID retaining circuit 208, a signal processing circuit 207, and a sensor 209. Change in the magnetic flux generated by the external coil is received by the internal coil of the chip, passed through a rectification circuit, stabilized by the power regulator block, and used as the power supply for driving the circuit blocks in the chip. A signal transmitted from the reader is demodulated by the RF interface 204, passed to the communication circuit 203, undergoes an ID compare sequence in which the chip ID number part of the signal is compared with the chip ID number retained by the chip ID retaining circuit 208, and, only when both ID number match, the signal is used to control the sensor. From the chip, sensed data digitized through the signal processing circuit 207 and the result of comparing the received chip ID number with the chip ID number retained by the chip ID retaining circuit 208 are passed through the communication control circuit 203, modulated by the RF interface 204, and transmitted to the reader by modulating the load of the coil 205.

It is assumed that the reader communicates with a plurality of chips. To stabilize such communication, it is required that the chips have a constant resonance frequency. However, due to variation in manufacturing the chips and depending on the circumstances where the chips are placed, for example, buffer solutions including different samples, other chips, or reaction containers exist around a chip, it is inevitable that the resonance frequency varies per chip. Resonance frequency difference due to variation in manufacturing the chips can be adjusted to a predetermined resonance frequency by trimming the capacitance of an individual chip. However, trimming increases the chip cost and is ineffective for resonance frequency variation depending on the circumstances around an individual chip. To overcome this problem, the RF interface 104 of the reader 101 is provided with a frequency variable function. Using this function, the frequency of the oscillator 107 is varied to adjust the carrier frequency to the resonance frequency of the chip to communicate with during measurement, so that the communication can be stabilized.

To stabilize the communication, frequency sweep is performed for the chips when initiating the communication. For example, if communication is to be performed at 13.56 MHz, a 12-18 MHz frequency band range is transmitted from the reader. Individual chips reply at an optimum frequency selected out of the swept frequency band and return the chip ID information to the reader, using the optimum frequency. The reader relates the return signal frequency from the chip to the chip ID for each chip and thus detects the resonance frequency corresponding the communication of each individual chip. The thus obtained correspondences of the IDs of the chips and the frequencies for communication with the chips can be stored on an external ROM or RAM of the application control unit so that the correspondences can be referenced when initiating communication with the chips again.

There are two main methods of frequency sweep. One method is to transmit pulses of electromagnetic waves of different frequencies in sequence; for example, in order of 13.56, 14.0, 14.5, 15.0 MHz, etc. Actually, if a frequency is used as a main carrier, the main frequency has predetermined side bands. If selected main frequencies are modulated by 0.5 MHz and the modulated pulses are transmitted, in consequence, a sweep over a substantially continuous frequency band can be performed. The other method is to transmit electromagnetic waves of continuous frequencies in a band; for example, continuous frequencies from 12 MHz to 8 MHz. In Embodiment 1, the frequency sweep is performed, using the second method. In other embodiments of the invention which will be described hereinafter, the frequency sweep is assumed to be performed in the same manner.

According to the above-described method, trimming for adjusting the resonance points of the chips is unnecessary and, therefore, the communication system of the invention can keep a lid on costs of the chips. Also, the communication system of the invention can dynamically accommodate resonance point shifts occurring, depending on the surroundings of the chips.

[Embodiment 2]

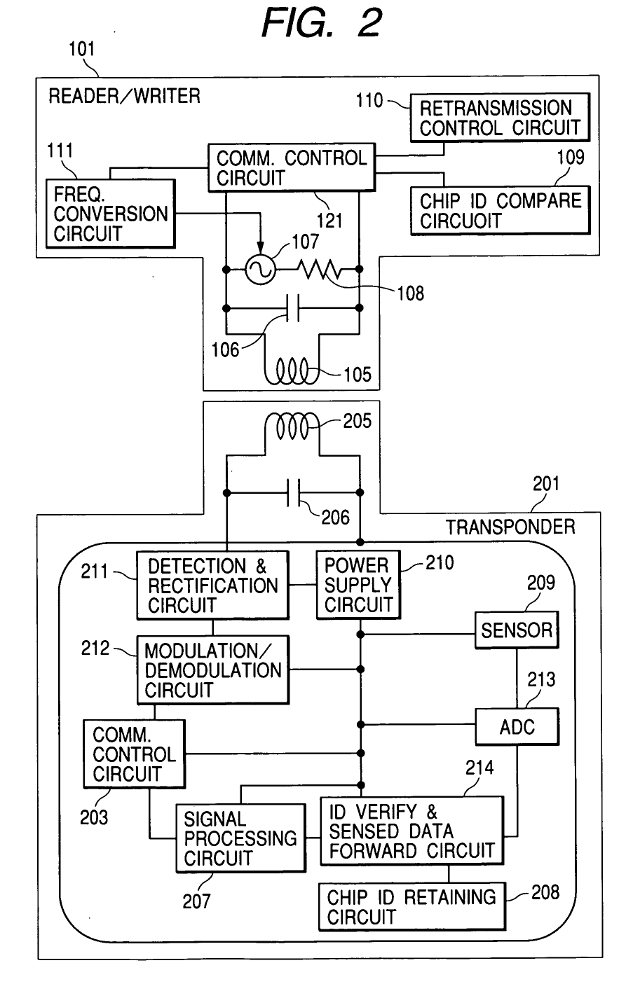

A concrete embodiment of the present invention will be described with reference to FIG. 2. FIG. 2 is a schematic diagram illustrating the function blocks of the reader and the chip according to the present invention. On the reader, a chip ID compare circuit 109 and a retransmission control circuit 110 are installed and a frequency-variable oscillator 107 including series internal resistance 108, wherein the oscillation frequency can be varied by a frequency conversion circuit 111 which operates by a control signal issued from a communication control circuit 121, an external coil 105, and external resonance capacitance 106 are connected in parallel and installed. Inside a chip 201, a circuit in which an internal coil 205 and internal resonance capacitance 206 are connected in parallel, a sensor 209, a detection and rectification circuit 211, a modulation/demodulation circuit 212, a communication control circuit 203, a signal processing circuit 207, an ID verify and sensed data forward circuit 214, a power supply circuit 210, an analog-digital converter (ADC) 213, and a chip ID retaining circuit 208 are installed. In the circuitry of the chip, the circuit in which the internal coil 205 and internal resonance capacitance 206 are connected in parallel connects to the detection and rectification circuit 211, the rectified output of the detection and rectification circuit 211 is supplied to the power supply circuit 210, the detection and rectification circuit 211 connects to the modulation/demodulation circuit 212, the modulation/demodulation circuit 212 connects to the communication control circuit 203, and the communication control circuit 203 connects to the signal processing circuit 207, the signal processing circuit 207 connects to the ID verify and sensed data forward circuit 214, the ID verify and sensed data forward circuit 214 connects via the ADC 213 to the sensor 209, the chip ID retaining circuit 208 connects to the ID verify and sensed data forward circuit 214, and the detection and rectification circuit 211, modulation/demodulation circuit 212, communication control circuit 203, signal processing circuit 207, ID verify and sensed data forward circuit 214, ADC 213, and sensor 209 are supplied with required power from the power supply circuit 210. Supplying power from the reader 101 to the chip 201 and transmitting data between the reader and the chip are performed through a magnetic path which is formed by magnetic flux generated by both the external coil 105 and the internal coil 205. The reader 101 reads a chip ID code which is required from the chip ID compare circuit 109. After proper modulation is performed, a carrier frequency fit for the chip ID code is selected, and the frequency-variable oscillator 107 generates an RF signal at the selected frequency under the control of the frequency conversion circuit 111. The RF signal having the chip ID and other data modulated thereon is supplied to a parallel resonance circuit consisting of the external coil 105 and external resonance capacitance 106. The external coil emits magnetic flux into space and this magnetic flux is captured by the chip's parallel resonance circuit consisting of the internal coil 205 and internal resonance capacitance 206 and the RF signal is transmitted to the detection and rectification circuit 211. The RF signal is rectified and its rectified output is accumulated in the power supply circuit 210 from which the thus accumulated power is supplied to other electronic circuits within the chip 201 and the sensor. On the other hand, the detected output from the detection and rectification circuit is demodulated by the modulation/demodulation circuit 212 and the chip ID code generated by the reader is reproduced by the communication control circuit 203 and signal processing circuit 207. The ID verify and sensed data forward circuit 214 compares this reproduced chip ID code with the chip ID number which is unique to the chip and retained by the chip ID retaining circuit 208 and a sequence of operation is repeated until both ID codes match. Only after verifying a match between the chip ID code generated by the reader and the chip ID number which is unique to the chip and the chip holds it in the chip ID retaining circuit 208, information sensed by the sensor 209 is input via the ADC 213 to the ID verify and sensed data forward circuit 214. The information is transferred via the signal processing circuit 207 and communication control circuit 203 to the modulation/demodulation circuit 212. After the information is modulated properly by the modulation/demodulation circuit into a signal having the data modulated thereon, the signal is passed through the detection and rectification circuit 211 and supplied as an RF signal to the parallel resonance circuit consisting of the internal coil 205 and internal resonance capacitance 206. The internal coil emits magnetic flux into space and this magnetic flux is captured by the reader's parallel resonance circuit consisting of the external coil 105 and external resonance capacitance 106 and the RF signal is transmitted to the reader 101. The above-described procedure is repeated a plurality of times at intervals of given time which is determined by the retransmission control circuit 110 built in the reader 101. In the measurement system of the present invention, a sufficient amount of electric energy must be transmitted from the reader to the chip through the magnetic path which is formed by the magnetic flux produced between the external coil integrated into the reader and the internal coil included in the chip. Therefore, a sequence of operation of RF signal transmission at a single frequency generated by the frequency-variable oscillator under the control of the frequency conversion circuit must be performed for sufficiently long time and an optimum number of times of retransmission relative to the level of accuracy at which the measurement system takes measurements must be selected by the retransmission control device. Because the reader acquires measurement results data by radio from chips having specific ID codes, the properties of materials of many kinds can be measured with a plurality of chips having different sensor functions and a diverse range of measurements of the materials can be taken and checked substantially at a time and quickly. Using a plurality of chips having different sensor functions or a plurality of chips having sensors to detect different objects, a plurality of substances existing in an analyte can be checked substantially at a time and quickly.

[Embodiment 3]

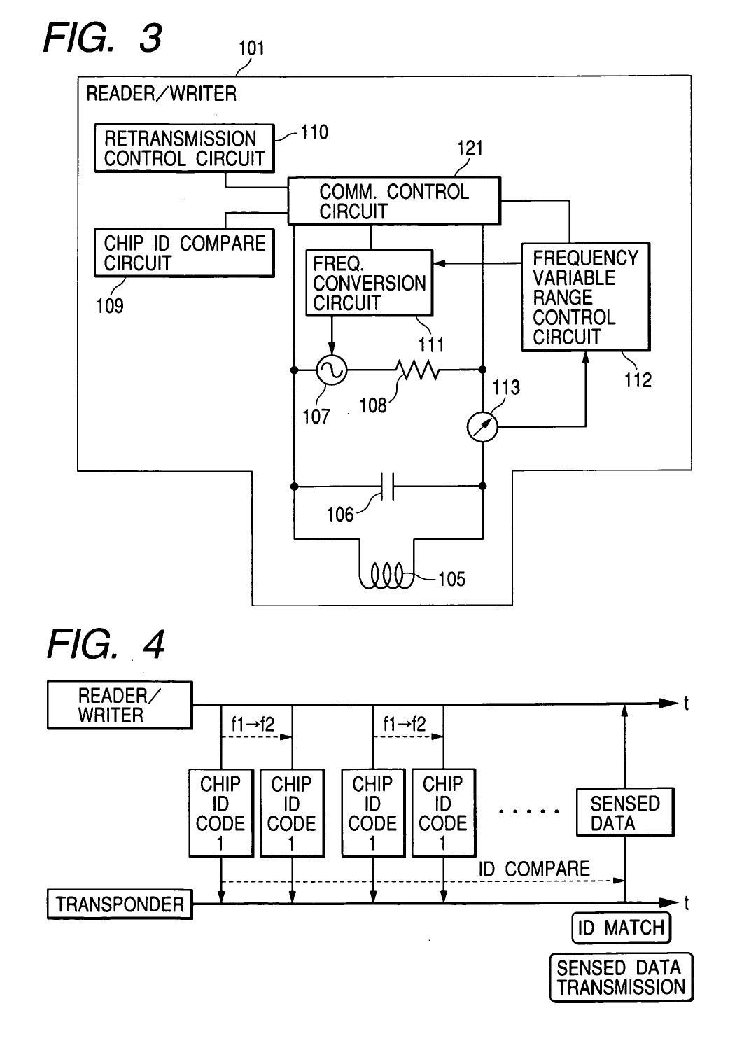

Another preferred embodiment of the present invention will be described, using FIG. 3. FIG. 3 is a schematic diagram showing electric circuitry of a reader in a measurement system of another embodiment of the present invention. This reader differs from the reader of Embodiment 2 shown in FIG. 2 in the following respects. Additionally, a frequency variable range control circuit 112 connects to the communication control circuit 121 and a current detector 113 is inserted in series across one of the lines which make parallel connection of the parallel circuit consisting of the internal coil 205 and internal resonance capacitance 206 and the series circuit consisting of the frequency-variable oscillator 107 and internal resistance 108. Using a signal detected by the current detector as an input control signal, the frequency variable range control circuit generates a control signal to dynamically change the frequency variable range and supplies this signal to the frequency conversion circuit 111. In the measurement system of the present invention, in order to transmit a sufficient amount of electric energy from the reader to the chip, a sequence of operation of RF signal transmission at a single frequency generated by the frequency-variable oscillator under the control of the frequency conversion circuit must be performed for sufficiently long time. However, because the internal coil and internal resonance capacitance within a chip are generally small and need to be produced at low cost, it is difficult to adjust their electrical characteristics uniformly. Frequency at which the chip's parallel resonance circuit consisting of the internal coil and internal resonance capacitance is electromagnetically coupled to the reader's parallel resonance circuit consisting of the external coil and external resonance capacitance most efficiently varies, depending on the manufacturing quality of the chip's parallel resonance circuit part. By varying the frequency of the magnetic flux generated by the external coil of the reader, transmission and reception of data and energy between the reader and the chip at the frequency at which the chip's parallel resonance circuit consisting of the internal coil and internal resonance capacitance is electromagnetically coupled to the reader's parallel resonance circuit consisting of the external coil and external resonance capacitance most efficiently can be realized. In this relation, it is desirable to cut off transmission and reception of data and energy between the reader and the chip at frequencies other than the frequency at which the chip's parallel resonance circuit consisting of the internal coil and internal resonance capacitance is electromagnetically coupled to the reader's parallel resonance circuit consisting of the external coil and external resonance capacitance most efficiently. At the frequency at which the chip's parallel resonance circuit consisting of the internal coil and internal resonance capacitance is electromagnetically coupled to the reader's parallel resonance circuit consisting of the external coil and external resonance capacitance most efficiently, the current detector output becomes great. Therefore, the output of the current detector is monitored by the frequency variable range control circuit and, in a range of frequencies generated by the frequency-variable oscillator controlled by the frequency conversion circuit, a frequency region for which the current detector output is relatively low is cut in steps. In consequence, time required for the measurement system to complete one cycle of measurement can be shortened. In the present embodiment, transmitting energy from the reader to the chips and transmitting data between the reader and the chips are not performed in an inefficient frequency region. Therefore, the following advantageous effects are obtained: time to be taken for the measurement system to take measurements is shortened and the power consumed by the system is reduced.

[Embodiment 4]

Yet another preferred embodiment of the present invention will be described, using FIG. 4. FIG. 4 shows a time sequential procedure of transmitting data between the reader (device) and the chip in the measurement system of another embodiment of the present invention. As regards frequency sweep in this embodiment illustrated in FIG. 4, one of the above-mentioned methods, that is, the method of transmitting electromagnetic waves of frequencies in given steps is used, and frequencies in 0.5-MHz steps in a predetermined range are transmitted from the reader when a frequency sweep is performed. First, the reader transmits data of chip ID code 1 to the chip, using magnetic flux at frequency f1. Then, the chip determines whether the chip ID code matches the ID number unique to the chip: If the chip ID code data from the reader does not arrive at the chip, the chip regards it as arrival of null data of chip ID code and determines that chip ID code 1 does not match the ID number unique to the chip. As described for Embodiment 2 of FIG. 2, after the repetition of transmission at the same frequency for sufficiently long time, the frequency of magnetic flux generated from the reader is changed to f2 (from f1) and, on the chip, comparing the received chip ID code with the ID number unique to the device (chip) is repeated. Once the above process has been terminated, the same process is repeated by a suitable number of times. During the repetition, when it has been detected that the chip ID code received by the measuring device (chip) matches the ID code unique to the device, the chip converts information from the sensor to sensed data and transmits the sensed data through magnetic flux generated by the internal coil to the reader. According to the present embodiment, the reader can selectively acquire only data from the chip which is sensing information that the reader operator wishes to get. In other words, the reader can identify data that a chip has, such as measurements taken by the sensor of the chip, from the chip ID code, and can acquire the data selectively. It can be checked in a non-contact manner whether a liquid sample has a specific property or includes a specific substance, wherein the liquid sample is measured by the chip situated in place.

[Embodiment 5]

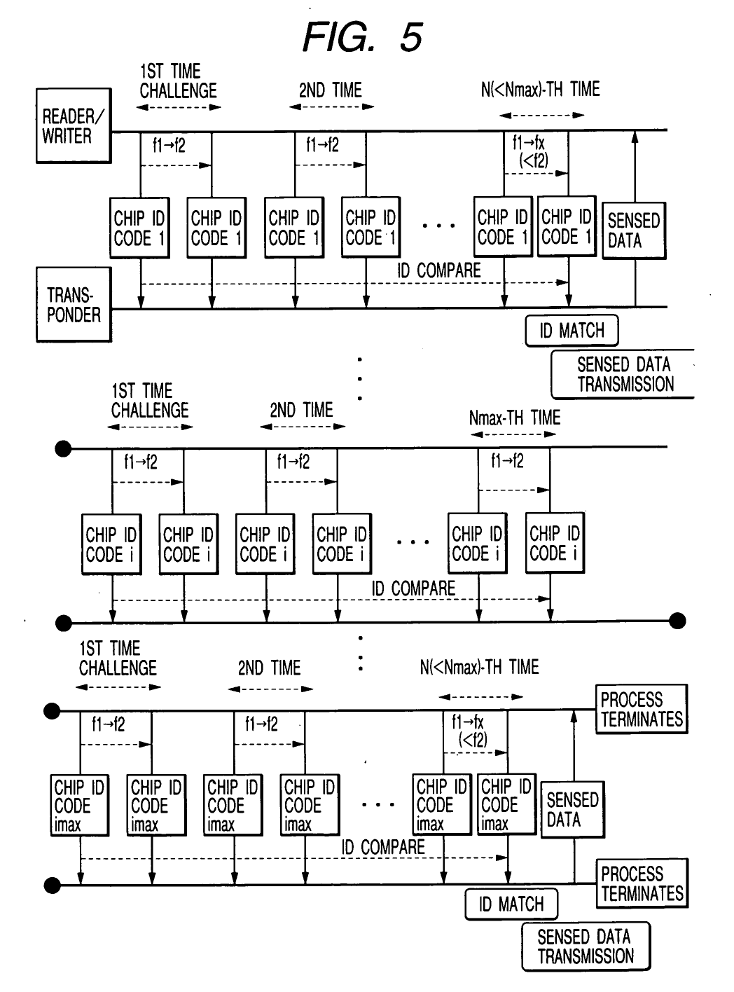

A further preferred embodiment of the present invention will be described, using FIG. 5. FIG. 5 shows a time sequential procedure of transmitting data between the reader and the chip in the measurement system of another embodiment of the present invention. First, the reader transmits data of chip ID code 1 to the chip, using magnetic flux at frequency f1. Then, the chip determines whether the chip ID code matches the ID number unique to the chip. If the chip ID code data from the reader does not arrive at the chip, the chip regards it as arrival of null data of chip ID code and determines that chip ID code 1 does not match the ID number unique to the chip. As described for Embodiment 2 of FIG. 2, after the repetition of transmission at the same frequency for sufficiently long time, the frequency of magnetic flux generated from the external control device is changed to f2 (from f1) and, on the chip, comparing the received chip ID code with the ID code unique to the device (chip) is repeated. During this process, relationship between a value detected by the current detector built in the reader and frequency being used for transmission is stored and the frequency variable range in which the frequency conversion circuit controls the frequency to be generated by the variable frequency oscillator is changed by the frequency variable range control circuit, when appropriate, so that the reader does not generate magnetic flux in a frequency region for which the current detector detects a relatively low value. As described above, due to variation in manufacturing the chips and depending on the circumstances where the chips are situated, for example, buffer solutions including different samples, other chips, or reaction containers exist around a chip, it is inevitable that the resonance frequency varies per chip. To overcome this problem, a signal detected by the current detector, based on which a control signal is generated to dynamically change the frequency variable range in which the oscillator of the reader generates frequencies, is related to the chip ID code and this correspondence is stored. Referring to this correspondence data, the reader varies the oscillator frequency to adjust the carrier frequency to the resonance frequency of the chip, according to the chip to communicate with, and, thereby, communication can be stabilized. The above process is repeated by a number of times determined by the retransmission control circuit built in the reader. During the repetition, when it has been detected that the chip ID code received by the chip matches the ID code unique to the device, the chip converts information from the sensor to sensed data and transmits the sensed data through magnetic flux generated by the internal coil to the reader. Upon the termination of a sequence of operation described above, the chip ID compare circuit is referenced and looked up. If another chip ID code is fund, the above sequence of operation is repeated for the found chip ID code. In this way, the sequence of operation is repeated until the sequence of operation is completed for all chip ID codes stored in the chip ID compare circuit. According to the present embodiment, if the reader operator wishes to get a plurality of items of information, the reader can selectively acquire only the relevant data from the chips which are sensing the information that the reader operator wishes to get. In other words, even if a plurality of chips are used, the reader can identify specific data that the chips have, such as measurements taken by the sensors of the chips, from the chips' ID codes, and can acquire the data selectively. When a plurality of chips which are appointed to detect different chemical reactions corresponding to the items of data are situated in place together to measure liquid samples, the reader can immediately check the items of data and time to be taken for the measurement system to take measurements can be shortened.

[Embodiment 6]

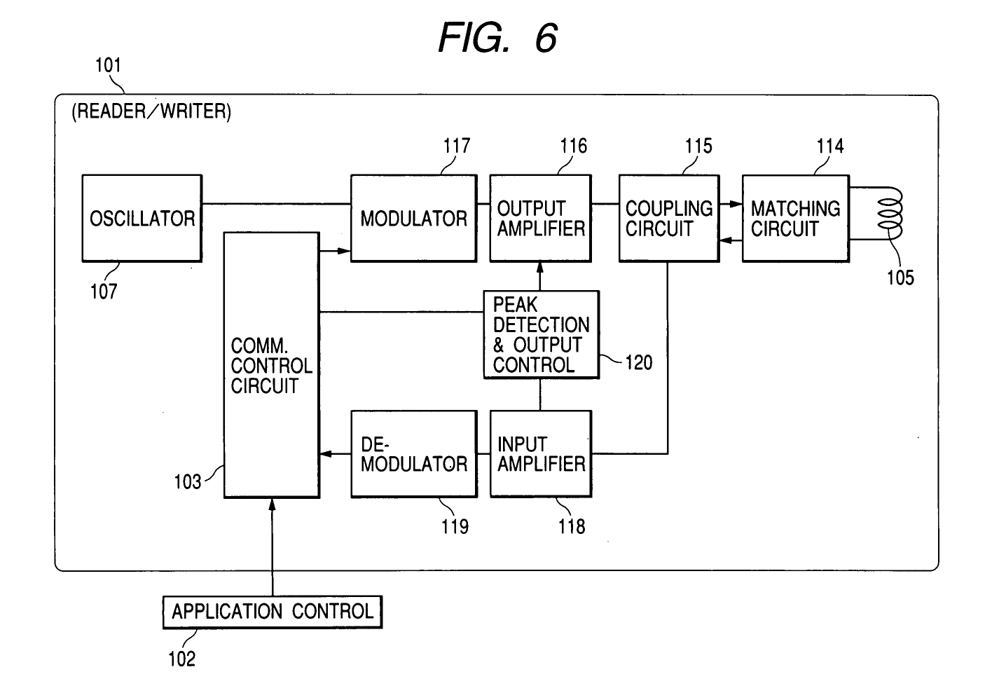

A still further preferred embodiment will be described, referring to FIG. 6. FIG. 6 is a schematic diagram showing a reader configuration in a measurement system of the present invention. The reader comprises an oscillator block 107, a communication control circuit block 103, a modulator block 117, an output amplifier block 116, a coupling circuit block 115, a matching circuit block 114, and external coil 105, an input amplifier block 118, a demodulator 119, and a peak detection and output control circuit block 120.

When current I flows across a coil having a radius R and N turns of windings, magnetic field strength at a point at a distance x from the center of the coil is expressed by the following equation (Equation 1) (for example, Non-Patent Document Cited).

$$H = \frac{I \cdot N \cdot {R}^{2}}{2 \sqrt{{( {R}^{2} + {x}^{2} )}^{3}}} \qquad [ Equation 1 ]$$

The above equation is true in the near field, that is, a region where x<λ/2π with regard to wavelength λ corresponding to frequency. If the chip is designed with distance x between the external coil of the reader and the internal coil of the chip being 2 mm, which is a normal value, and if x becomes 0.5 mm, magnetic field strength sensed by the coil of the chip becomes 64 times as much as a design standard value. When electric power far exceeding the design value is generated in the chip, there is a possibility of breakdown of the power regulator and rise in the chip temperature. Voltage tolerance of a chip depends on the LSI process for forming the circuitry on the chip. Voltage tolerances for sections of the device such as semiconductor pn junctions, source-drain sections of MOS transistors, gate insulation layers, sections between two wiring conductors are designed to meet required standard values. Changing the LSI process to enhance the voltage tolerances leads to a great increase in cost.

The above problem can be solved by detecting a peak voltage of input signals and controlling the output as shown in FIG. 6. The reader output is controlled, according to the strength of signals from the chips, so as to avoid chip breakdown and prevent temperature rise. Thus, output can be set to accommodate various conditions of measurement almost without changing the chip design.

[Embodiment 7]

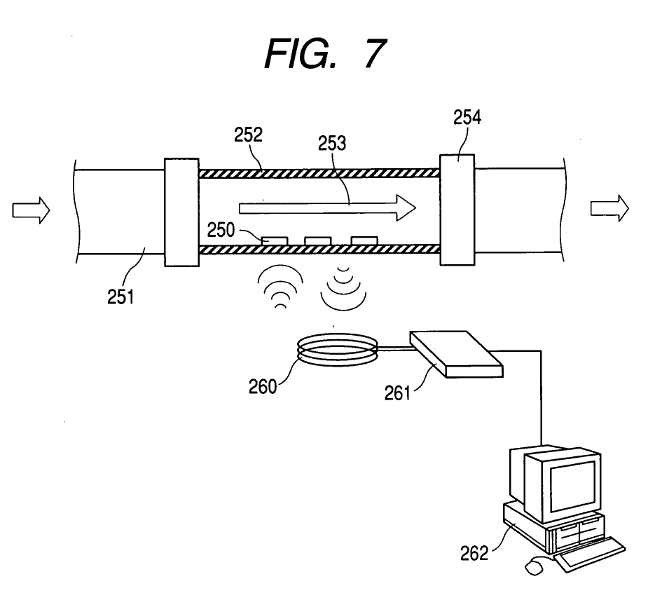

A yet further preferred embodiment will be described, referring to FIG. 7. FIG. 7 is a schematic of a measurement system application example to a plant, featuring a function of wirelessly measuring liquid conditions in a pipe, using chips installed inside the pipe and a reader installed outside the pipe. When liquid conditions in a pipe are measured by a conventional sensing system, lead wires are necessary to draw out sensing signals outside the pipe. As a means of lead taps, sealed through-hole electrodes are used. However, such problems may occur as leakage from the sealed electrodes, impurity incursion, and the electrodes cause stagnation of fluid flowing through the pipe. For example, when a plurality of items are measured or when many sensors are used to measure liquid distribution, lead tap structures become complex, which causes decrease in reliability and cost increase. According to the present embodiment, conditions inside the pipe can be monitored in a non-contact and wireless manner. Moreover, this system can be provided in a simple structure and at a low cost. Because the reader and chips which have been described in the foregoing embodiments are used, digitized sensed data from raw data detected by the sensors of the chips inside the pipe and the result of chip ID code comparison with the ID number retained by the chip ID retaining circuit are transmitted through the communication control circuit to the reader outside the pipe. By obtaining corresponding between a chip ID number and chip location information beforehand, conditions in any given position inside the pipe can be monitored wirelessly. To stabilize communication between the reader and the chips, it is required that the chips have a constant resonance frequency. However, due to variation in manufacturing the chips and depending on the circumstances where the chips are installed, for example, solution which flows through the pipe and for which measurements should be taken, other chips or reaction containers exist around a chip, it is inevitable that the resonance frequency varies per chip. Resonance frequency difference due to variation in manufacturing the chips can be adjusted to a predetermined resonance frequency by trimming the capacitance of an individual chip. However, trimming increases the chip cost and is ineffective for resonance frequency variation depending on the circumstances around an individual chip. Therefore, the RF interface of the reader should be provided with a frequency variable function. Using this function, the frequency of the oscillator is varied to adjust the carrier frequency to the resonance frequency of the chip to communicate with during measurement, so that the communication can be stabilized. According to this method, the trimming for adjusting the resonance points of the chips is unnecessary and, therefore, costs can be saved. Also, it is possible to dynamically accommodate resonance point shifts occurring, depending on the surroundings of the chips.

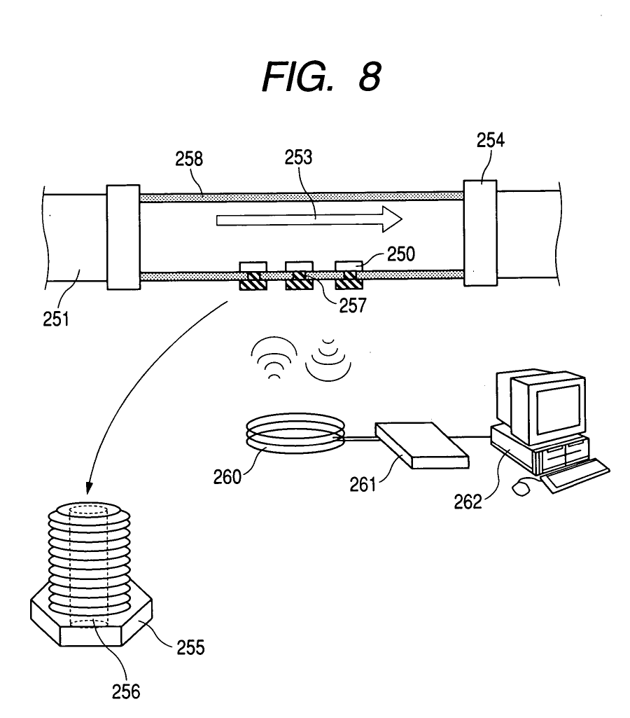

As concrete embodiment, the chips 250 are attached to the inside walls of the pipe 252 and communicate with the reader 261 via a coil 260 outside the pipe. The thickness of the chips is substantially equivalent to the thickness of a silicone semiconductor substrate and the chips 1-mm thick or thinner can be produced. As for the material of the pipe, the walls 252 to which the chips are installed should have less conductivity, as shown in FIG. 8, so that the efficiency of electromagnetically coupling of the chip's coil and the reader's coupling can be enhanced and communication characteristics can be improved.

FIG. 8 shows a configuration example for enhancing the communication efficiency of the present embodiment. Stainless pipes are widely used for piping in plants because they are excellent in corrosion resistance, strength, and reliability. However, stainless pipes are highly conductive and may cause trouble in communications environment. FIG. 8 explains a pipe structure in which conventional material is used as much as possible and material capable of enhancing communication efficiency is introduced only in places where such material is necessary. The pipe 252 inside which the chips are installed is made of basically the same material as other pipe portions 251 where the chips are not installed and minimum necessary through holes 257 are provided only in places where the chips are installed. A part 255 which functions as the passage of magnetic lines of force and has core material 256 which is of high permeability, that is, allowing magnetic lines of force to pass through it easily and in which eddy current hardly occurs is inserted in each through hole 257. Even if the same material as used conventionally, for example, stainless is used as the material 258 of the pipe inside which the chips are arranged, the measurement system of the present invention can be applied.

[Embodiment 8]

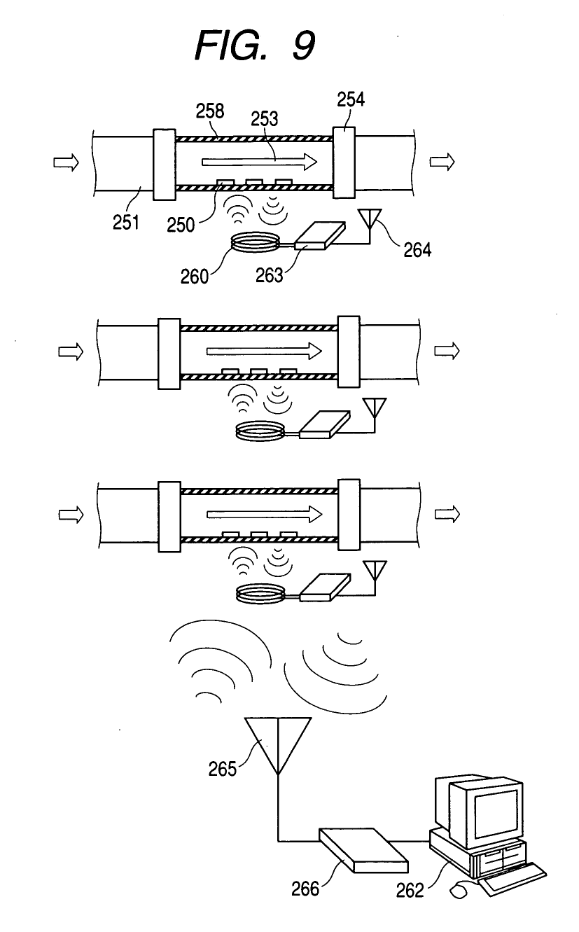

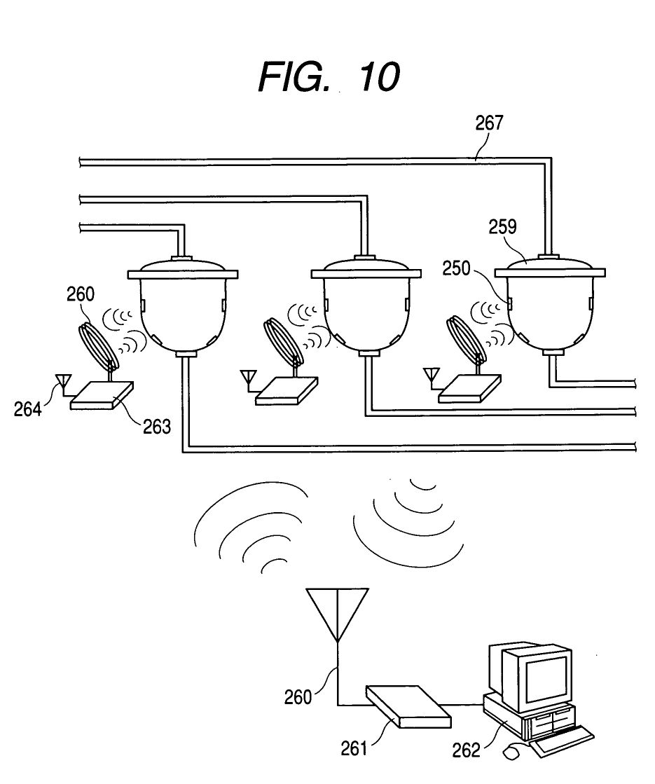

A still further embodiment of the present invention is shown in FIG. 9. In the measurement system of the present invention, the communication between the chips and the read is principally performed in a passive mode; that is, the chips have no power supply and required electric power is supplied by RF carriers from the reader. The passive mode is very effective for downsizing the chips and curtailing costs, but its communication range is limited. Embodiment 8 provides a method for extending the communication range effectively. As the reader which drives the coil outside the pipe, a reader 263 is used which includes a long-range communication function via an antenna 64 added to the reader 261 which is shown in FIG. 10, and data communication is performed via an antenna 265 and a transmitter/receiver (transceiver) 266 connected to an external control device 262. This system makes it possible to monitor conditions inside many pipes which are located in remote places in a non-contact manner. FIG. 10 shows an example of application of the system of FIG. 9 to synthetic reaction baths. In FIG. 10, reference numeral 260 denotes a coil outside the piping, 264 denotes a transmitter/receiver, 263 denotes a reader, 259 denotes a synthetic reaction bath, and 267 denotes piping.

Configuration for enhancing the communication efficiency described for FIG. 8 can be applied in the present embodiment also.

[Non-Patent Document Cited]

Klaus Finkenzeller, RFID HAND BOOK: 1999, John Wily & Sons Ltd.

What is claimed is:

1. A communication system comprising:
a plurality of chips, each including a sensor, a chip ID retaining circuit for retaining a chip ID number, and a first resonance circuit; and
a reader comprising a second resonance circuit configured for carrying out transmission and/or reception of data to or from said plurality of chips, a frequency conversion circuit, and a chip ID compare circuit for comparing said chip ID number of each said chip for a match;
wherein, based on said chip ID retaining circuit, said frequency conversion circuit is configured to adjust carriers to a resonance frequency which is optimum per said chip and which has been obtained by a frequency sweep beforehand, and said reader is configured to communicate with each of said chips at said resonance frequency.

2. The communication system according to claim 1 wherein said reader further comprises data storage for storing resonance frequency information which stores a list of correspondence between said chip ID number and said optimum resonance frequency.

3. The communication system according to claim 1, further comprising an external control device which connects to said reader, said external control device including data storage for storing resonance frequency information and which stores a list of correspondence between said chip ID number and said optimum resonance frequency.

4. The communication system according to claim 1, wherein said resonance frequency is determined separately for each of said chips by said first resonance circuit on each of said chips.

5. The communication system according to claim 1, wherein said resonance frequencies are determined separately for each of said chips owing to circumstances around each said chip.

6. The communication system according to claim 1, wherein each of said chips further comprises a radio frequency (RF) control unit which comprises a rectification circuit, demodulation circuit, and modulation circuit, a power supply control unit, a communication control circuit, and a signal processing circuit,
wherein said signal processing circuit is configured to digitize signals detected by said sensor;
said demodulation circuit is configured to compare said data received with said chip ID number retained by said chip ID retaining circuit and demodulate said data;
and wherein said modulation circuit is configured to modulate the digitized signals detected by said sensor; and
the modulated digital signals detected by said sensor are transmitted by radio frequency (RF) to said reader.

7. The communication system according to claim 1, wherein said sensor is configured to measure the quantity, temperature, or pressure of an object to detect.

8. The communication system according to claim 1, further comprising:
a transport mechanism comprising piping and containers, wherein said chips are installed in said transport mechanism and said reader is placed outside said transport mechanism.

9. The communication system according to claim 8, wherein said sensor is configured to detect the conditions of a liquid fluid present inside said transport mechanism.

10. The communication system according to claim 8, wherein said chips are configured to communicate with said reader and transmit said chip ID number and measurements detected by said sensor;
and said chip ID number is corresponded to position information for each of said chips.

11. The communication system according to claim 8, wherein sections of said piping where said chips are installed have lower conductivity than other sections.

12. The communication system which is applied to the transport mechanism according to claim 8, wherein sections of said piping where said chips are installed have through holes and cores are inserted in said through holes.

13. The communication system according to claim 8, wherein said chips are supplied with required electric power by radio frequency transmission from said reader.

14. The communication system which is applied to the transport mechanism according to claim 8, further comprising:
an external control device which is installed outside said transport mechanism,
a transceiver connected to said external control device,
a transceiver antenna connected to said transceiver, and a reader antenna connected to said reader,
wherein said reader is provided with an additional long-range communication function and communicates with said external control device via said reader antenna, said transceiver antenna, and said transceiver.

15. A communicating reader comprising a resonance circuit, an oscillator, and a radio frequency control unit which includes a frequency conversion circuit,
wherein said resonance circuit and said oscillator carries out signal transmission and reception for communication with chips and a frequency sweep for said chips; and
said frequency conversion circuit is configured to convert a transmitting frequency to each of said chips to a resonance frequency for communication with each of said chips, based on said frequency sweep.

16. The communicating reader according to claim 15, further comprising a chip ID compare circuit which retains chip ID codes independently retained on said chips and compares said chip ID codes for a match.

17. The communicating reader according to claim 15, further comprising a mechanism for controlling the strength of signals to be transmitted to said chips, according to the strength of signals received from said chips.

18. A communication method comprising:
transmitting from a reader information containing a chip ID code while performing a frequency modulation;
detecting in a chip whether there is a match between said chip ID code transmitted from the reader and a chip ID number unique to said chip; and
transmitting from said chip a result of detecting said match signals detected by a sensor included on said chip to said reader,
wherein, in said detecting step, said chip compares both of said chip ID code and said chip ID number for a match during said frequency modulation.

19. The communication method according to claim 18, wherein said information transmitting step and said detecting step are repeated until a match between both of said ID codes is detected.

20. The communication method according to claim 18, wherein a plurality of chips are used and each of said chips detects whether there is a match between said chip ID code received from said reader and said chip ID number unique to each of said chips.
